(19) United States
(12) Patent Application Publication
(10) Pub. No.: US 2011/0135367 A1
(43) Pub. Date: Jun. 9, 2011

(54) TAPE PRINTER, METHOD FOR CONTROLLING TAPE PRINTER, AND COMPUTER PROGRAM PRODUCT

(75) Inventor: Hideyuki Tsukuda, Matsumoto-shi (JP)

(73) Assignee: Seiko Epson Corporation, Tokyo (JP)

(21) Appl. No.: 12/951,167

(22) Filed: Nov. 22, 2010

(30) Foreign Application Priority Data
Dec. 3, 2009 (JP) 2009-275224

(51) Int. Cl. B41J 11/44

(52) U.S. Cl. 400/76

(57) ABSTRACT

A tape printer which prints an image based on an entered character string on a tape member to be attached to an object to be sent, the tape printer comprising: a keyboard that accepts an entry of a first character string indicating a destination, and an entry of a second character string indicating sender information; an image generating section that generates a first image representing the destination based on the first character string, and a second image representing the sender information based on the second character string; and a printing section that prints the first image and the second image on the tape member.

### CROSS-REFERENCE

The present application claims priority from Japanese Patent Application No. 2009-275224 filed on Dec. 3, 2009, which is hereby incorporated by reference in its entirety.

### BACKGROUND

In recent years, a tape printer that can print destination information such as a zip code, an address, and a name has been known. For example, a destination printer that generates a customer bar code and performs destination printing including the customer bar code has been disclosed (for example, Japanese Patent Publication No. 2000-237692). On the other hand, a tape printer that prints a two-dimensional code on a tape member, the two-dimensional code that can store character string information or the like, has been disclosed (for example, Japanese Patent Publication No. 2009-18430). Moreover, information such as an address of a sender is sometimes printed in advance on an object (mail) to be sent, such as a postcard or an envelope. Furthermore, when the sender is a company, URL information of a web page including the corporate information or advertising information is often printed on an object to be sent, such as a postcard or an envelope.

However, in such a tape printer, printing of the address information such as a destination address and name and printing of address information such as the sender's address and name and URL information such as corporate information have to be performed separately. This makes the operation complicated.

In addition, when the information such as an address of the sender is printed on an object to be sent, such as a postcard or an envelope, the information becomes old if the address etc. of the sender is changed, making it impossible to use the postcard or the envelope. Moreover, since the URLs of various web pages including corporate information, advertising information, etc. are often changed, they soon become old after they are printed on a postcard or an envelope.

### SUMMARY

Various embodiments may solve at least part of the problems described above, and the invention can be realized as forms or application examples described below.

### Application Example 1

According to at least one embodiment of the disclosure, there is provided a tape printer which prints an image based on an entered character string on a tape member to be attached to an object to be sent, the tape printer including: a keyboard that accepts an entry of a first character string indicating a destination, and an entry of a second character string indicating sender information; an image generating section that generates a first image representing the destination based on the first character string, and a second image representing the sender information based on the second character string; and a printing section that prints the first image and the second image on the tape member.

According to such a tape printer, the keyboard accepts an entry of a first character string indicating a destination. The image generating section generates a first image representing a destination based on the first character string. The keyboard accepts a second character string indicating sender information. The image generating section generates a second image representing the sender information based on the second character string. The printing section prints the first image and the second image on a tape member. That is, the tape printer accepts character strings indicating a destination and sender information, generates an image based on the destination and an image based on the sender information, and prints these images on the tape member. This makes it possible to print not only the image of the destination but also the image of the sender information on the tape member to be attached to an object to be sent, such as a postcard or an envelope. Therefore, the tape printer is useful because there is no need to print the sender information in advance on an object to be sent, such as a postcard or an envelope. Moreover, a sender can enter the sender information as new information at all times with a simple method.

### Application Example 2

The tape printer according to the application example described above, the keyboard accepts a predetermined entry operation, and a printing section prints the second image on the tape member based on the predetermined entry operation, the predetermined entry operation representing whether the second image is printed or not.

According to such a tape printer, the printing selecting section selects whether or not to make the printing section print the second image on the tape member based on the predetermined entry operation. As a result, the user can select whether or not to print the sender information on the tape member, and print the sender information with a simple method. This enhances convenience.

### Application Example 3

In the tape printer according to the application example described above, the second image representing the sender information may be an image of a two-dimensional code.

According to such a tape printer, the second image is an image of a two-dimensional code. As a result, the sender information is represented by a two-dimensional code, making it possible to convey a lot of information in a small printing area.

### Application Example 4

In the tape printer according to the application example described above, the image of the two-dimensional code may be an image of one of a QR Code®, a PDF417®, a Data Matrix®, a Maxi Code® and a Veri Code®.

According to such a tape printer, the second image is an image of one of a QR code, a PDF417, a Data Matrix, a Maxi Code and a Veri Code. As a result, the sender information is represented by one of a QR code, a PDF417, a Data Matrix, a Maxi Code and a Veri Code, making it possible to convey a lot of information in a small printing area. Moreover, the QR code is useful because the QR code can deal with numeric data, alphanumeric data, kanji character data, and binary data and express a large number of characters, and thereby convey various information as the sender information.

### Application Example 5

According to at least one embodiment of the disclosure, there is provided a method for controlling a tape printer which prints an image based on an entered character string on a tape member to be attached to an object to be sent, the method including: accepting an entry of a first character string indicating a destination, and an entry of a second character string indicating sender information by a keyboard; generating a first image representing the destination based on the first character string, and a second image representing the sender information based on the second character string; and printing the first image and the second image on the tape member.

According to such a method for controlling a tape printer, the tape printer accepts character strings indicating a destination and sender information, generates an image based on the destination and an image based on the sender information, and prints these images on the tape member. This makes it possible to print not only the image of the destination but also the image of the sender information on the tape member to be attached to an object to be sent, such as a postcard or an envelope, by a simple operation.

### Application Example 6

According to at least one embodiment of the disclosure, there is provided a computer program product for making a computer execute the steps of the method in the application example described above for controlling a tape printer.

By making the computer execute such a program product, the tape printer accepts character strings indicating a destination and sender information, generates an image based on the destination and an image based on the sender information, and prints these images on the tape member. This makes it possible to print not only the image of the destination but also the image of the sender information on the tape member to be attached to an object to be sent, such as a postcard or an envelope, by a simple operation.

Moreover, the forms and application examples described above can be configured as a recording medium etc. which records the program product in such a way that the program product can be read by the computer. As the recording medium, various media that can be read by the computer, the media such as a flexible disk and a hard disk, an optical disk such as a CD and a DVD, a magneto-optical disk, a memory card and USB memory which incorporate nonvolatile semiconductor memory, and internal memory (semiconductor memory such as RAM and ROM) of an image generating apparatus, can be used.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is a perspective view showing a tape printer of an embodiment.

FIG. 2 is a perspective view showing the tape printer of the embodiment.

FIG. 3 is a block diagram showing a circuit configuration of the tape printer.

FIGS. 4A to 4D are explanatory diagrams showing the screen of a display section of the tape printer in a delivery information entry state, FIG. 4A being an explanatory diagram showing a screen which makes the user enter a destination, FIG. 4B being an explanatory diagram showing a screen which makes the user select a QR code use, FIG. 4C being an explanatory diagram showing a screen which makes the user enter a character string of a QR code, and FIG. 4D being an explanatory diagram showing a screen which makes the user enter a character string of a comment.

FIG. 5 is an explanatory diagram showing a destination printing confirmation screen in a destination printing state of the tape printer.

FIG. 6 is a flowchart for explaining destination printing processing.

FIG. 7 is an explanatory diagram of a QR code printing selection screen.

FIGS. 8A and 8B are plan views showing a label on which destination printing has been performed, FIG. 8A being a plan view of a destination printed label on which a QR code is printed, and FIG. 8B being a plan view of a destination printed label on which a QR code is not printed.

### DESCRIPTION OF EMBODIMENTS

Hereinafter, a tape printer which prints an image based on an entered character string on a tape member (hereinafter referred to as a “tape”) to be attached to an object to be sent will be described with reference to the drawings.

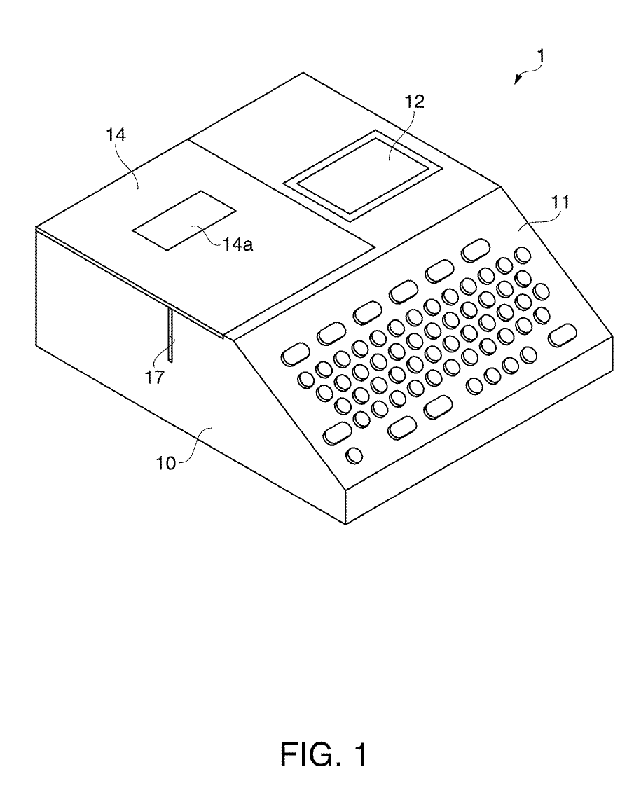

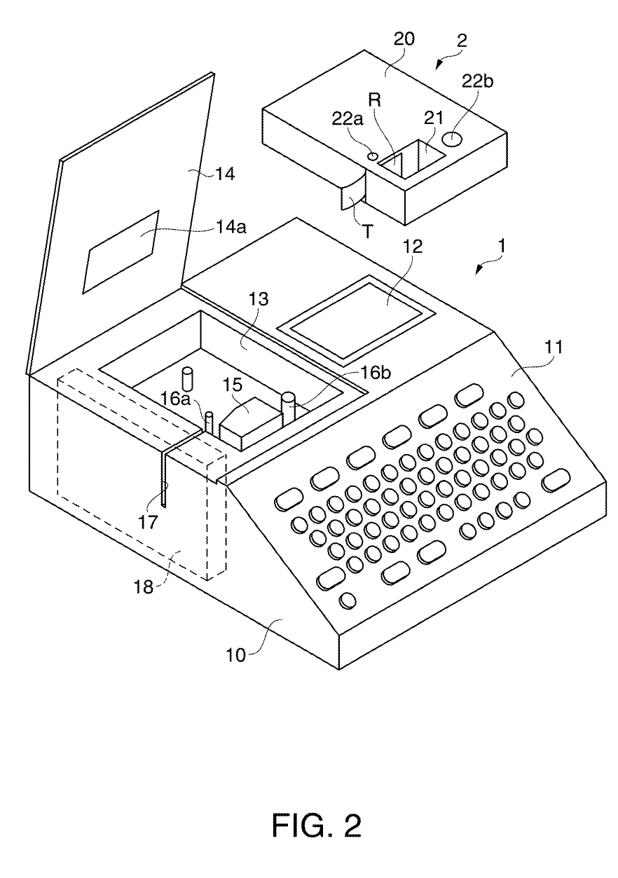

FIGS. 1 and 2 are perspective views showing a tape printer of an embodiment.

As shown in FIGS. 1 and 2, a tape printer 1 has a structure in which a main body is housed in a cabinet 10, and the cabinet 10 has a keyboard 11 on the front upper face thereof. The keyboard 11 is an entry section which accepts various entry operations, such as an entry of a character string, performed by the user, and has a large number of character keys by which a character string composed of a kana character, a kanji character, an alphabet, a numeric, a symbol, etc. can be entered and a plurality of control keys for giving an instruction of various operations to the tape printer 1. The control keys of the keyboard 11 include a power supply key for switching between on and off of a power supply, a conversion key for converting entered kana characters into a kanji character, an enter key for confirming the entered character string or the like, a cursor key used, for example, to move a cursor, a printing key for making the tape printer 1 perform printing, a destination entry key for performing destination entry, a destination printing key for making the tape printer 1 perform destination printing, etc.

The cabinet 10 has a display section 12 formed of a liquid crystal display device and the like on the upper face thereof near the back. The display section 12 forms an image with a large number of pixels arranged in a matrix, and is used to display a character entered from the keyboard 11 and display a menu screen and a message screen.

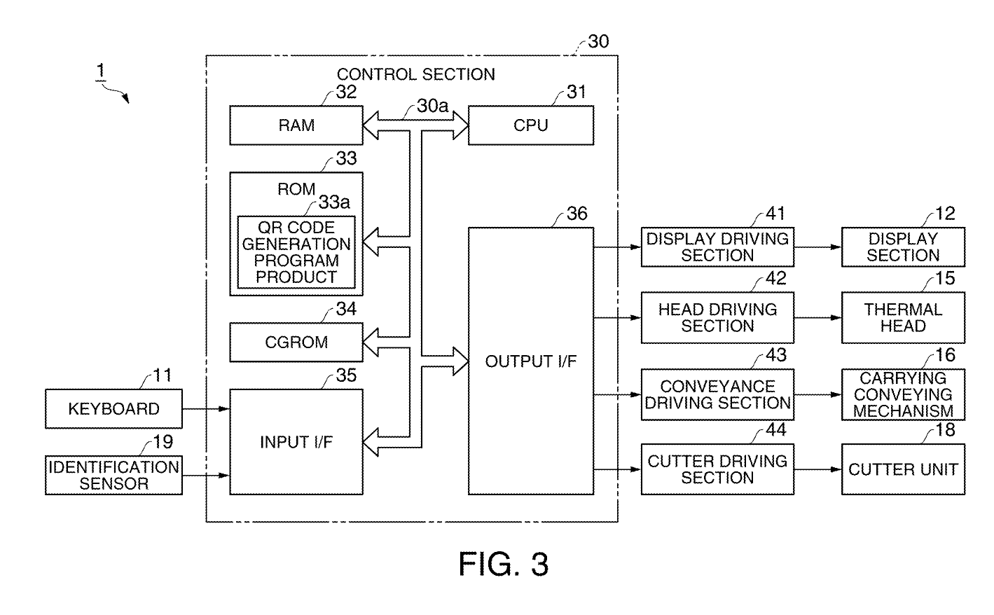

Next to the display section 12, the cabinet 10 has a concave portion 13 formed on the upper face thereof near the back. The concave portion 13 into which a tape cartridge 2 is placed. On the opening of the concave portion 13, an opening and closing lid 14 is provided so as to be openable and closable, and, by bringing the opening and closing lid 14 into an open state, the tape cartridge 2 can be attached and detached. Moreover, the opening and closing lid 14 has a translucent confirmation window 14a, which allows the user to check visually and externally whether the tape cartridge 2 is placed in the concave portion 13 or not. At the bottom of the concave portion 13, a thermal head 15 and rotating shafts 16a and 16b forming a conveying mechanism 16 (see FIG. 3) are provided. When the tape cartridge 2 is placed into the concave portion 13, the thermal head 15 fits into a hole-shaped head fit portion 21 provided in the tape cartridge 2, and the rotating shafts 16a and 16b are engaged in hole-shaped driven sections 22a and 22b, respectively.

The tape cartridge 2 has a built-in tape T and a built-in ink ribbon R, of which both are belt-shaped, in a cartridge case 20. The tape T is a printing medium of the tape printer 1, and has a structure in which an adhesive layer is formed on the back of a base material formed of PET (polyethylene terephthalate) or paper material and the adhesive layer is coated with release paper. The tape printer 1 can support two or more types of tape cartridge 2 which differ in width, material (material of the base material), color, etc. of the tape T, and the user can use a tape cartridge 2 according to the use or preference. Incidentally, on the back of the tape cartridge 2, a plurality of holes (not shown) are provided for identifying the built-in tape T, whereby the tape printer 1 can identify the tape type of the tape cartridge 2 placed in the concave portion 13 by an identification sensor 19 (see FIG. 3), such as a microswitch, provided on the bottom of the concave portion 13.

When the tape cartridge 2 is placed into the concave portion 13, the front surface of the tape T faces the thermal head 15 in the head fit portion 21 with the ink ribbon R placed between the tape T and the thermal head 15. The thermal head 15 has a large number of heater elements (not shown) formed therein and arranged in line in a direction perpendicular to the longitudinal direction (the direction in which the tape T is conveyed) of the tape T. Each heater element is made to generate heat, whereby the ink of the ink ribbon R is transferred (thermally transferred) to the front surface of the tape T. That is, a dot is formed on the front surface of the tape T in a position corresponding to the heater element which has generated heat. Here, when the rotating shafts 16a and 16b are driven and rotated, the tape T and the ink ribbon R are conveyed, the tape T is then ejected to the outside of the cartridge case 20, and the ink ribbon R is reeled in the cartridge case 20. Then, by repeating the above-described thermal transfer while gradually conveying the tape T and the ink ribbon R, an image formed of a plurality of dots is printed on the front surface of the tape T.

In a side face of the cabinet 10, a slit 17 which makes the outside of the cabinet 10 and the concave portion 13 communicate with each other is provided, and the printed tape T ejected from the cartridge case 20 passes through the slit 17, and a predetermined length thereof is conveyed toward the outside of the cabinet 10. Inside the cabinet 10, a cutter unit 18 for cutting the tape T crossing the slit 17 is provided. The printed part of the tape T is cut by the cutter unit 18, and is ejected out of an opening (a tape ejection port) of the slit 17 as a tape piece (a label).

FIG. 3 is a block diagram showing a circuit configuration of the tape printer 1.

As shown in FIG. 3, in addition to the keyboard 11, the display section 12, the thermal head 15, the conveying mechanism 16 including the rotating shafts 16a and 16b (see FIG. 2), the cutter unit 18, and the identification sensor 19 which have been described above, the tape printer 1 includes a control section 30 which performs centralized control of the operation of the tape printer 1, a display driving section 41 which makes the display section 12 display an image, a head driving section 42 which drives the thermal head 15 and makes the thermal head 15 generate heat, a conveyance driving section 43 which drives the conveying mechanism 16, a cutter driving section 44 which drives the cutter unit 18, etc.

The control section 30 functions as a computer, and has a CPU (central processing unit) 31, RAM (random access memory) 32, ROM (read only memory) 33, CGROM (character generator ROM) 34, an input interface (I/F) 35, an output interface (I/F) 36, and the like, which are connected with each other via a bus 30a.

The CPU 31 operates in accordance with a control program product stored in the ROM 33, and controls various operations of the whole of the tape printer 1.

The RAM 32 is a storage section formed of volatile memory, and temporarily stores various processing results of the CPU 31, a character code string entered from the keyboard 11, display image data to be displayed by the display section 12, printing image data to be printed by the thermal head 15, etc. Moreover, the RAM 32 also stores document data, destination data, and the like, which are formed of a character code string. Incidentally, the document data, the destination data, and the like, may be stored in flash memory or the like which is nonvolatile memory.

The ROM 33 and the CGROM 34 are storage sections formed of nonvolatile memory such as mask ROM or flash memory, and the ROM 33 stores the above-described control program product, various data, and the like. Moreover, the ROM 33 stores a QR code generation program product 33a for generating image data of a QR code. The QR code generation program product 33a is supplied from Denso Wave Incorporated and executed at the time of destination printing including a QR code.

The CGROM 34 stores font data of characters which can be printed by the tape printer 1. The font data is data in the bit map format, and the data is for generating a character to be printed by the thermal head 15 and a character to be displayed by the display section 12. The font data in the bit map format is formed of a large number of dots, and each dot corresponds to the heater element of the thermal head 15 and the pixel of the display section 12. The CGROM 34 stores font data of a plurality of fonts, and the CPU 31 acquires corresponding font data from the CGROM 34 by specifying a font type, a character size, and a character code, and generates display image data and printing image data by using this font data. Incidentally, as the font data, font data in an outline format, which is easily related to various character sizes, may be used.

To the input interface 35, the keyboard 11 and the identification sensor 19 are connected. When the keyboard 11 is operated by the user, the keyboard 11 accepts this operation, and outputs key information corresponding to the operated key to the CPU 31 via the input interface 35. Here, the keyboard 11, the input interface 35, and the CPU 31 correspond to an operation accepting section. Moreover, the identification sensor 19 outputs identification information according to the tape type of the tape cartridge 2 placed in the concave portion 13 to the CPU 31 via the input interface 35.

To the output interface 36, the display driving section 41, the head driving section 42, the conveyance driving section 43, and the cutter driving section 44 are connected, and these sections drive the display section 12, the thermal head 15, the conveying mechanism 16, and the cutter unit 18, respectively, based on the control from the CPU 31.

In the tape printer 1 configured as described above, when the power supply key is operated by the user, the tape printer 1 starts operating, whereby characters can be entered by means of the character keys, and various instructions can be given by means of the control keys.

Here, when a character is entered as a result of the character key being operated by the user, the keyboard 11 accepts this entry, and outputs key information to the control section 30. Based on the key information input from the keyboard 11, the control section 30 identifies a character code of the entered character, and stores the character code in the RAM 32. Then, the control section 30 acquires font data corresponding to the character code from the CGROM 34, and generates display image data by using the font data thus acquired. When the control section 30 supplies the display image data to the display driving section 41, the entered character is displayed on the display section 12. Then, when the user repeats an entry of a character multiple times, a character code string (text data) including a plurality of character codes is stored in the RAM 32, and a character string formed of a plurality of characters is displayed on the display section 12.

When the printing key is operated by the user after the character (character string) is entered, the tape printer 1 performs printing processing.

Here, the tape printer 1 of this embodiment can perform “destination entry” by which a character string (destination information) of a destination is entered and “destination printing” by which an image based on the character string of the destination is printed on the tape T. Furthermore, the tape printer 1 allows an entry of sender information in addition to the destination information, and can print the sender information on the tape T as an image of a QR code.

First, an entry of the destination information and an entry of the sender information will be described. In this embodiment, when the “destination entry key” of the keyboard 11 is pressed, the state transitions to a delivery information entry state in which an entry of the destination information and an entry of the sender information are accepted.

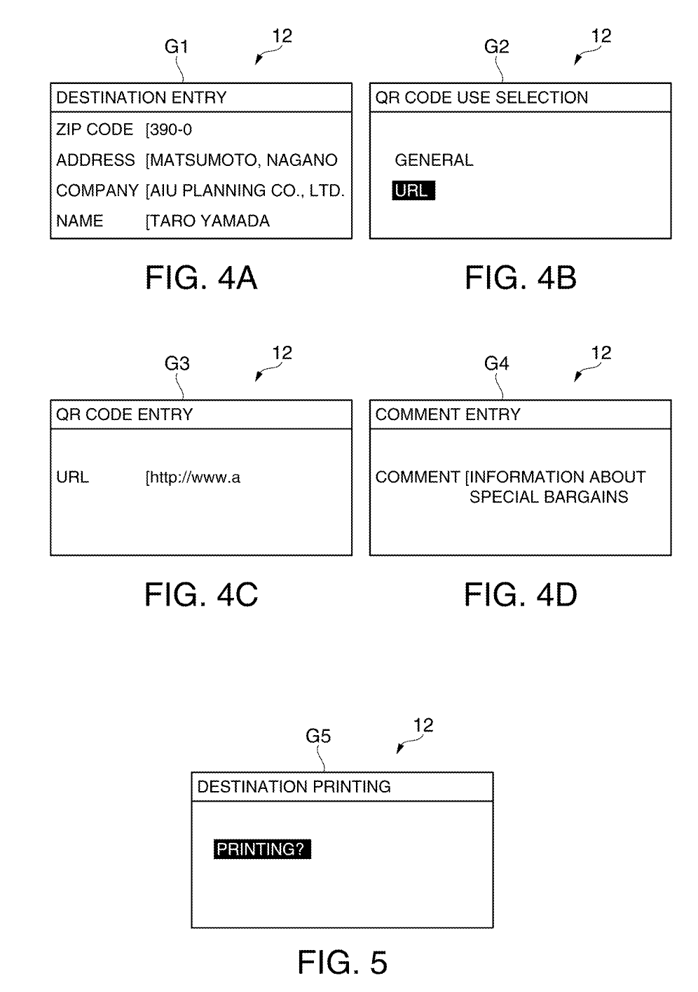

FIGS. 4A to 4D are explanatory diagrams showing the screen of the display section 12 in a delivery information entry state of the tape printer 1. Here, FIG. 4A is an explanatory diagram showing a screen which makes the user enter a destination, FIG. 4B is an explanatory diagram showing a screen which makes the user select a QR code use, FIG. 4C is an explanatory diagram showing a screen which makes the user enter a character string of a QR code, and FIG. 4D is an explanatory diagram showing a screen which makes the user enter a character string of a comment.

FIG. 4A is a destination entry screen G1 which makes the user enter a destination. In the uppermost part of the destination entry screen G1, the character string of “DESTINATION ENTRY” indicating that this screen is a destination entry screen is displayed. Under that character string, the character strings of “ZIP CODE”, “ADDRESS”, “COMPANY”, and “NAME” are displayed in this order, and, on the right side of “ZIP CODE”, “ADDRESS”, “COMPANY”, and “NAME”, character string entry fields in which the user enters character strings are provided. When the user enters an arbitrary character string which becomes a destination in the character string entry field by using the keyboard 11, the control section 30 stores the entered character string in the RAM 32 as destination data. The keyboard 11 and the control section 30 here correspond to a first entry section, and the arbitrary character string here, which becomes a destination, corresponds to a first character string.

FIG. 4B is a QR code use selection screen G2 which makes the user select a QR code use. In this embodiment, the QR code use selection screen G2 is displayed when entries in the destination entry screen G1 is completed, and is displayed to enter the sender information. In the uppermost part of the QR code use selection screen G2, the character string of “QR CODE USE SELECTION” indicating that this screen is a QR code use selection screen is displayed. Under that character string, the character strings of “GENERAL” and “URL” are displayed in this order. The user can select “GENERAL” or “URL” by pressing the cursor key of the keyboard 11 and then pressing the Enter key. Here, “GENERAL” is selected to generate a QR code of an arbitrary character string, and “URL” is selected to generate a QR code of a character string of the URL of a web page. Incidentally, the option which is currently selected is displayed in a black-and-white highlighted character.

FIG. 4C is a QR code entry screen G3 which makes the user enter a QR code. The QR code entry screen G3 is a screen which is displayed when the “URL” is selected as the use of a QR code. In the uppermost part of the QR code entry screen G3, the character string of “QR CODE ENTRY” indicating that this screen is a QR code entry screen is displayed. Under that character string, the character string of “URL” is displayed, and, on the right side thereof, a character string entry field in which the user enters a character string is provided. When the user enters an arbitrary character string which represents the URL of a web page in the character string entry field by using the keyboard 11, the control section 30 stores the entered character string in the RAM 32 as QR code data. The keyboard 11 and the control section 30 here correspond to a second entry section, and the arbitrary character string here, which is the URL of a web page, corresponds to a second character string.

FIG. 4D is a comment entry screen G4 which makes the user enter a comment which is additional information of the QR code. The comment is a character string which is printed along with the QR code. In this embodiment, the comment entry screen G4 is displayed when entries in the QR code entry screen G3 is completed. In the uppermost part of the comment entry screen G4, the character string of “COMMENT ENTRY” indicating that this screen is a comment entry screen is displayed. Under that character string, the character string of “COMMENT” is displayed, and, on the right side thereof, a character string entry field in which the user enters a character string is provided. When the user enters an arbitrary character string which becomes a comment in the character string entry field, the entered character string is stored in the RAM 32 as comment data.

As described above, when the character strings are entered in the destination entry screen G1, the QR code use selection screen G2, the QR code entry screen G3, and the comment entry screen G4 in the delivery information entry state, the tape printer 1 can make the RAM 32 store the character strings of the destination, the QR code, and the comment. In this embodiment, a plurality of pieces of destination data, QR code data, and comment data can be stored. When destination printing is performed in a state in which the character strings of the destination data, the QR code data, and the comment data are stored, the tape printer 1 can print the character string of the destination and the character strings of the QR code and the comment on the tape T.

Next, destination printing will be described. In this embodiment, when the “destination printing key” of the keyboard 11 is pressed in a state in which intended destination data is selected by the user, the tape printer 1 displays a destination printing confirmation screen, and transitions to a destination printing state.

FIG. 5 is an explanatory diagram showing a destination printing confirmation screen G5 in a destination printing state of the tape printer 1. In the uppermost part of the destination printing confirmation screen G5, the character string of “DESTINATION PRINTING” indicating that this screen is a destination printing confirmation screen is displayed. Under that character string, the character string of “PRINTING?” is displayed in a black-and-white highlighted character. The user can perform destination printing by pressing the “Enter key” of the keyboard 11.

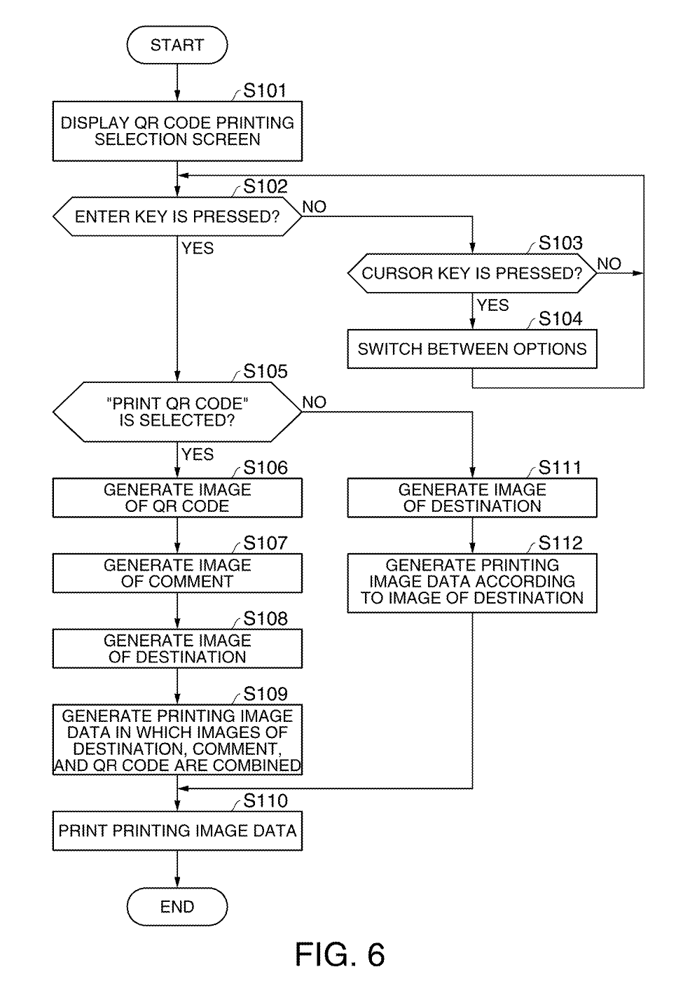

When the user performs destination printing in the destination printing confirmation screen G5, the tape printer 1 performs processing (flowchart) shown in FIG. 6.

FIG. 6 is a flowchart for explaining destination printing processing. The destination printing processing will be described by using FIG. 6.

When printing is performed by the user, the control section 30 makes the display driving section 41 display a QR code printing selection screen (step S101). Then, the control section 30 determines whether the Enter key of the keyboard 11 is pressed or not (step S102). Here, the QR code printing selection screen is a screen which makes the user select and decide whether or not to print the QR code.

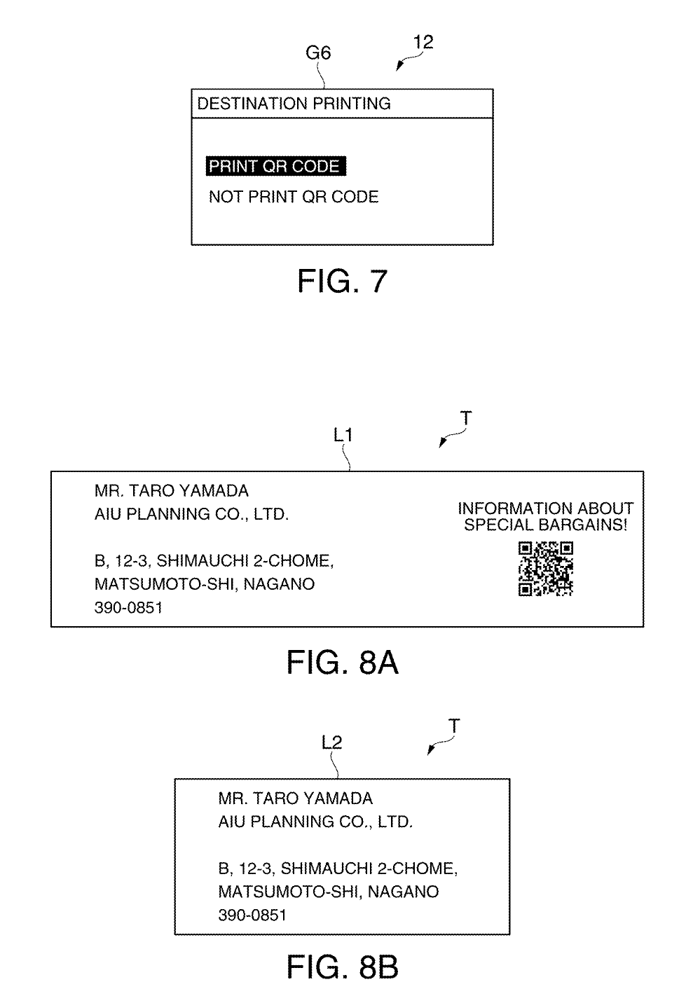

FIG. 7 is an explanatory diagram of a QR code printing selection screen G6. As shown in FIG. 7, in the uppermost part of the printing selection screen G6, the character string of “DESTINATION PRINTING” is displayed. Under that character string, the character strings of “PRINT QR CODE” and “NOT PRINT QR CODE” are displayed in this order. The user selects “PRINT QR CODE” or “NOT PRINT QR CODE” and confirms the selection by pressing the cursor key of the keyboard 11 and then pressing the Enter key. Incidentally, an option which is currently selected is displayed in a black-and-white highlighted character.

Back in FIG. 6, if the Enter key is not pressed (step S102: NO), the control section 30 determines whether the cursor key is pressed or not (step S103). If the cursor key is pressed (step S103: YES), the control section 30 switches between the options of the QR code printing selection screen G6 (step S104). Then, the procedure goes back to step S102. If the cursor key is not pressed (step S103: NO), the procedure goes back to step S102.

If the Enter key is pressed (step S102: YES), the control section 30 determines whether “PRINT QR CODE” is selected or not (step S105). If “PRINT QR CODE” is selected (step S105: YES), the control section 30 executes the QR code generation program product 33a stored in the ROM 33, generates image data of the QR code based on the QR code data which has been entered in the QR code entry screen G3 and stored in the RAM 32, and stores the image data in the RAM 32 (step S106). The control section 30 here corresponds to a second image generating section. Moreover, pressing of the Enter key corresponds to a predetermined entry operation.

The control section 30 generates image data of the character string of the comment based on the comment data which has been entered in the comment entry screen G4 and stored in the RAM 32 (step S107). Specifically, the control section 30 acquires font data corresponding to the comment data from the CGROM 34, generates image data of the character string of the comment, and stores the image data in the RAM 32.

The control section 30 generates image data of the character string of the destination based on the destination data which has been entered in the destination entry screen G1 and stored in the RAM 32 (step S108). Specifically, the control section 30 acquires font data corresponding to the destination data from the CGROM 34, generates image data of the character string of the destination, and stores the image data in the RAM 32. The control section 30 here corresponds to a first image generating section, and the image data of the character string of the destination here corresponds to a first image.

The control section 30 combines the image data of the character string of the destination, the image data of the character string of the comment, and the image data of the QR code, which are stored in the RAM 32, according to a predetermined arrangement, and generates printing image data for destination printing (S109). Incidentally, in this embodiment, the predetermined arrangement for destination printing is determined in advance by the tape width of the tape cartridge 2 placed in the concave portion 13.

The control section 30 prints the generated printing image data for destination printing on the tape T (step S110). Specifically, based on the printing image data, the control section 30 makes the head driving section 42 and the conveyance driving section 43 drive the thermal head 15 and the conveying mechanism 16, respectively, and makes them print an image according to the printing image data on the tape T. Thereafter, when the control section 30 makes the cutter driving section 44 drive the cutter unit 18, the tape T is cut, whereby a label on which the character string of the destination, the character string of the comment, and the QR code are printed is completed. Then, the control section 30 ends the destination printing processing of the tape printer 1. The control section 30, the head driving section 42, the conveyance driving section 43, the thermal head 15, and the conveying mechanism 16 here correspond to a printing section.

If “PRINT QR CODE” is not selected (step S105: NO), the control section 30 generates image data of the character string of the destination based on the destination data which has been entered in the destination entry screen G1 and stored in the RAM 32 (step S111). Specifically, the control section 30 acquires font data corresponding to the destination data from the CGROM 34, generates image data of the character string of the destination, and stores the image data in the RAM 32.

The control section 30 arranges the image data of the character string of the destination stored in the RAM 32, according to a predetermined arrangement, and generates printing image data for destination printing (step S112). Then, the control section 30 proceeds to step S110, and prints an image according to the printing image data on the tape T. Then, the control section 30 ends the destination printing processing of the tape printer 1.

Incidentally, the control section 30 which performs control for switching between processing by which the image data of the QR code is printed (processing in step S106 and steps that follow) and processing by which the image data of the QR code is not printed (processing in step S111 and steps that follow) according to the result as to whether “PRINT QR CODE” is selected or not (step S105) corresponds to a printing selecting section.

As described above, as destination printing, the tape printer 1 can print a character string of a destination and, as sender information, a character string of a comment and a QR code on the tape T. Moreover, the tape printer 1 can select not to print the sender information (a character string of a comment and a QR code).

Next, a tape T (a label) on which destination printing has been performed will be described.

FIGS. 8A and 8B are plan views showing a label on which destination printing has been performed. Here, FIG. 8A is a plan view of a destination printed label on which a QR code is printed, and FIG. 8B is a plan view of a destination printed label on which a QR code is not printed.

As shown in FIG. 8A, on a destination printed label L1 on which a QR code is printed, from the top left part of the drawing, the zip code, the address, the company, and the name which have been entered in the destination entry screen G1 are printed. In addition, on the right side of the drawing, the comment which has been entered in the comment entry screen G4 and the QR code based on the URL which has been entered in the QR code entry screen G3 are printed. The printed comment and QR code correspond to a second image.

In FIG. 8B, a destination printed label L2 on which a QR code is not printed is shown. As in the case with the destination printed label L1, the zip code, the address, the company, and the name are printed on the destination printed label L2, but a comment and a QR code which correspond to the second image are not printed.

The following effects are obtained by the embodiment described above.

(1) The tape printer 1 accepts an entry of a character string of a destination and an entry of a character string of a QR code as sender information. Then, the tape printer 1 generates image data of the destination and image data of the QR code, and prints, on the tape T, printing image data obtained by combining the above image data according to a predetermined arrangement. As a result, it is possible to print not only the destination information but also the QR code which is the sender information on the tape T to be attached to an object to be sent, such as a postcard or an envelope. This is useful because doing so eliminates the need to print the sender information on an object to be sent, such as a postcard or an envelope. Moreover, since the QR code (the sender information) can be changed on an as-needed basis, it is possible to update the sender information at all times.

(2) The tape printer 1 can make the display section 12 display the QR code printing selection screen G6, and make the user select whether or not to print the QR code on the tape T. As a result, the user is allowed to select whether or not to print the QR code (the sender information) on the tape T depending on the need. This makes it possible to attach the sender information with a simple method.

(3) The tape printer 1 prints the sender information as a QR code. This makes it possible to convey a lot of information in a small printing area. Moreover, the QR code is useful because the QR code can deal with numeric data, alphanumeric data, kanji character data, and binary data and express a large number of characters, and thereby convey various information as the sender information.

(4) The tape printer 1 can enter and print a character string of a comment as additional information of a QR code. As a result, a recipient who has received an object to be sent can grasp the outline etc. of the QR code by reading the comment. This enhances convenience.

The invention is not limited in any way by the embodiment thereof described above, and many variations and modifications are possible. Modified examples will be described below.

### Modified Example 1

In the embodiment described above, the tape printer 1 prints the sender information as a QR code; however, the invention is not limited thereto. For example, the sender information may be a two-dimensional code other than a QR code, such as a PDF417, a Data Matrix, a MaxiCode and a Veri Code. Moreover, the sender information may be a character string or the like.

### Modified Example 2

In the embodiment described above, the tape printer 1 generates a QR code representing a character string of the URL of a web page; however, the tape printer 1 may generate a QR code of an arbitrary character string. By doing so, it is possible to notify a recipient of an object to be sent of various information.

### Modified Example 3

In the embodiment described above, a QR code printing selection screen G6 is displayed in a destination printing state so as to make the user select whether or not to print a QR code; however, the user may be made to select whether or not to print a QR code after (or before) the user is made to enter a destination in a delivery information entry state.

### Modified Example 4

In the embodiment described above, the tape printer 1 displays the QR code use selection screen G2, the QR code entry screen G3, and the comment entry screen G4 after the destination entry screen G1, and makes the user enter the sender information. However, the tape printer 1 may make the user enter the sender information by displaying the QR code use selection screen G2, the QR code entry screen G3, and the comment entry screen G4 as independent screens which are not related to the destination entry screen G1. Doing so eliminates the need to enter sender information (a QR code) every time a destination entry is made. Moreover, this enhances convenience because it is possible to combine the destination information and the sender information arbitrarily.

### Modified Example 5

In the embodiment described above, destination printing is performed when the user enters the destination information and the sender information by pressing the destination entry key and then pressing the destination printing key. However, an entry of the destination information, an entry of the sender information, and destination printing may be performed as consecutive steps when the user presses a predetermined key of the keyboard 11.

### Modified Example 6

In the embodiment described above, on the destination printed label L1 printed by the tape printer 1, a QR code is printed on the right side of FIG. 8A; however, the invention is not limited thereto. For example, a QR code may be printed on the lower side of the drawing, the upper side of the drawing, or the left side of the drawing.

### Modified Example 7

In the embodiment described above, as a printing method for printing a character etc. on the tape T, a thermal transfer method by the thermal head 15 is used; however, the invention is not limited thereto. Other printing methods such as an ink-jet method by which an ink drop is discharged may be used.

What is claimed is:

1. A tape printer which prints an image based on an entered character string on a tape member to be attached to an object to be sent, the tape printer comprising:
a keyboard that accepts an entry of a first character string indicating a destination, and an entry of a second character string indicating sender information;
an image generating section that generates a first image representing the destination based on the first character string, and a second image representing the sender information based on the second character string; and
a printing section that prints the first image and the second image on the tape member.

2. The tape printer according to claim 1, wherein
the keyboard accepts a predetermined entry operation, and a printing section prints the second image on the tape member based on the predetermined entry operation, the predetermined entry operation representing whether the second image is printed or not.

3. The tape printer according to claim 1, wherein
the second image representing the sender information is an image of a two-dimensional code.

4. The tape printer according to claim 3, wherein
the image of the two-dimensional code is an image of one of a QR code, a PDF417, a Data Matrix, a MaxiCode and a Veri Code.

5. A method for controlling a tape printer which prints an image based on an entered character string on a tape member to be attached to an object to be sent, the method comprising:
accepting an entry of a first character string indicating a destination, and an entry of a second character string indicating sender information by a keyboard;
generating a first image representing the destination based on the first character string, and a second image representing the sender information based on the second character string; and
printing the first image and the second image on the tape member.

6. The method according to claim 5, further comprising:
accepting a predetermined entry operation by the keyboard; and
printing the second image on the tape member based on the predetermined entry operation, the predetermined entry operation representing whether the second image is printed or not.

7. The method according to claim 5, wherein
the second image representing the sender information is an image of a two-dimensional code.

8. The method to claim 7, wherein
the image of the two-dimensional code is an image of one of a QR code, a PDF417, a Data Matrix, a MaxiCode and a Veri Code.

9. A computer program product for making a computer execute the steps of the method for controlling a tape printer according to claim 5.
